(19) United States
(12) Patent Application Publication
(10) Pub. No.: US 2014/0297339 A1
(43) Pub. Date: Oct. 2, 2014

(54) MANAGEMENT SYSTEM, MANAGEMENT DEVICE, AND MANAGEMENT METHOD

(71) Applicant: FUJITSU LIMITED, Kawasaki-shi (JP)

(72) Inventors: Tomoko Tanaka, Inagi (JP); Hidekazu Arao, Yokohama (JP); KATSUSHI WAKIYAMA, Yokohama (JP); Teruko Mabuchi, Meguro (JP)

(73) Assignee: FUJITSU LIMITED, Kawasaki-shi (JP)

(21) Appl. No.: 14/187,709

(22) Filed: Feb. 24, 2014

(30) Foreign Application Priority Data
Mar. 28, 2013 (JP) 2013-069075

(51) Int. Cl. G06Q 10/02

(52) U.S. Cl. CPC G06Q 10/02
USPC 705/5

(57) ABSTRACT

A management system includes a memory storing first information including a user identification and a first reservation time period of an information processing device, and a processor coupled to the memory and configured to activate the first information at a start of the first reservation time period, deactivate the first information at an end of the first reservation time period, receive the first information from the information processing device, and permit an operation of the information processing device based on the first information stored in the memory and the first information sent by the information processing device.

### CROSS-REFERENCE TO RELATED APPLICATION

This application is based upon and claims the benefit of priority of the prior Japanese Patent Application No. 2013-069075, filed on Mar. 28, 2013, the entire contents of which are incorporated herein by reference.

### FIELD

The embodiments discussed herein are related to a management system, a management device, and a management method.

### BACKGROUND

There is a service that lends information processing devices, such as notebook-sized personal computers (PC), to users. In such a service, for example, a user within a company reserves lending of an information processing device with a specified lending time period. In addition, for the specified lending time period, the information processing device is lent to the user that made the reservation.

In addition, as a technique for collectively managing resources such as computers on a network, directory services have prevailed. For example, “ACTIVE DIRECTORY (registered trademark)” of Microsoft has been widely known. In general, the directory service includes a function for authenticating users utilizing resources on a network.

In addition, as techniques for authenticating a user or an information processing device, the following techniques exist. For example, there has been proposed a technique in which, by starting up an information security program, a coupled network environment is acquired from a network interface, inputting of a password is requested when a lending environment is different from usual, and, by judging, on the oasis of the coincidence of the password, whether or not lending is lending to a user having legitimate authority, it is possible to avoid the leakage of important information.

In addition, there has been proposed a technique in which a terminal is authenticated on the basis of, for example, the history of specific information that is included in login information and has been stored when a user has been authenticated on the basis of a relationship between authenticated information included in login information sent from the terminal and stored authentication information and hence, illegal lending due to a third person is detected. Examples of a related document include International Publication Pamphlet No. WO2005/111825 and Japanese Laid-open Patent Publication No. 2006-202196.

### SUMMARY

According to an aspect of the embodiments, a management system includes a memory storing first information including a user identification and a first reservation time period of an information processing device, and a processor coupled to the memory and configured to activate the first information at a start of the first reservation time period, deactivate the first information at an end of the first reservation time period, receive the first information from the information processing device, and permit an operation of the information processing device based on the first information stored in the memory and the first information sent by the information processing device.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram illustrating an example of a configuration and an example of processing of a lending management system of a first embodiment;

FIG. 2 is a diagram illustrating an example of a configuration of a lending reservation system of a second embodiment;

FIG. 3 is a diagram illustrating an example of a hardware configuration of a lending reservation device;

FIG. 4 is a diagram illustrating an example of a function of a lending reservation system;

FIG. 5 is a diagram illustrating an example of a lending reservation table;

FIG. 6 is a diagram illustrating an example of a MAC address table;

FIG. 7 is a diagram illustrating an example of an authentication table;

FIG. 8 is a diagram illustrating an example of a display folder table;

FIG. 9 is a diagram illustrating an example of an affiliation table;

FIG. 10 is a diagram illustrating an example of an authority information table;

FIG. 11 is a diagram for explaining processing for restricting a usable time period of an information processing device and an individual piece of an information processing device to be used;

FIG. 12 is a diagram for explaining processing for displaying a display folder in an information processing device whose use has been permitted;

FIG. 13 is a sequence illustrating examples of a lending reservation and a lending start;

FIG. 14 is a sequence illustrating an example of use of an information processing device;

FIG. 15 is a sequence illustrating an example of an operation at the end of a lending time period;

FIG. 16 is a flowchart illustrating an example of lending reservation processing;

FIG. 17 is a first flowchart illustrating an example of lending processing;

FIG. 18 is a second flowchart illustrating an example of lending processing;

FIG. 19 is a flowchart illustrating an example of authentication processing; and

FIG. 20 is a flowchart illustrating an example of lending end processing.

### DESCRIPTION OF EMBODIMENTS

In general, in a lending service for information processing devices, a management device is used for managing the information of users who made reservations and information processing devices serving as lending targets. However, such a management device simply holds the information of users or the information of lending reservation time periods, and it is difficult for such a management device to put a restriction so that a lent information processing device is able to be used for only a lending reservation time period.

Hereinafter, the present embodiment will be described with reference to drawings.

### First Embodiment

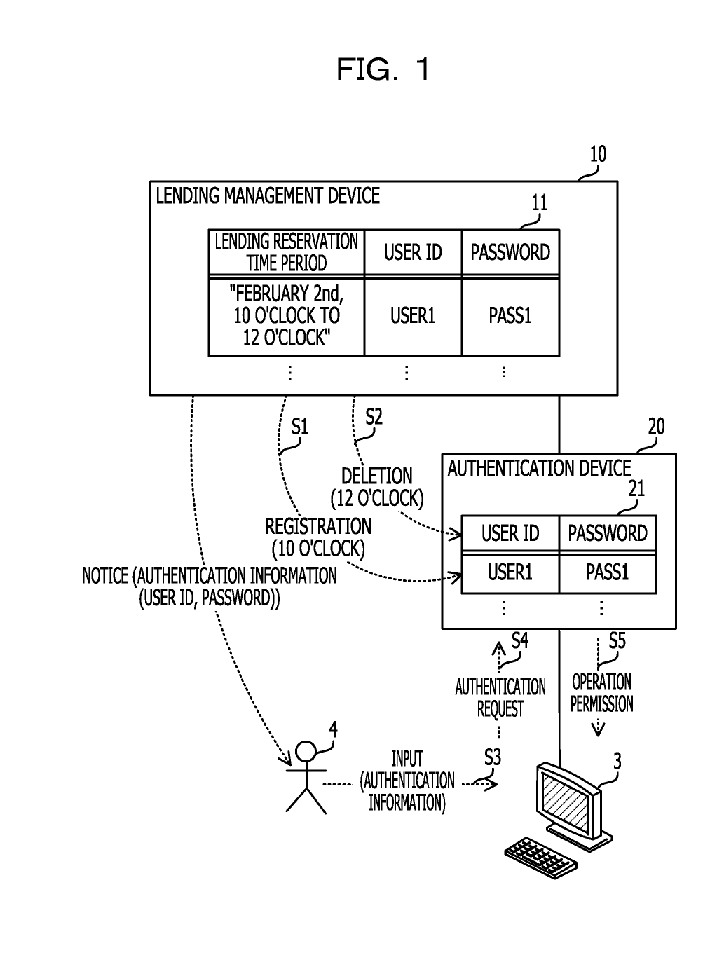

FIG. 1 is a diagram illustrating an example of the configuration and an example of processing of a lending management system of a first embodiment. The present lending management system is a system managing lending of an information processing device to a user.

The present lending management system includes an information processing device 3, a lending management device 10, and authentication device 20. From among these, the information processing device 3 is a device serving as a target of lending to a user.

The lending management device 10 manages the authentication information of a user serving as the lending destination of the information processing device 3 and a lending reservation time period. For example, the lending management device 10 includes a storage unit 11, and stores the authentication information of a user and the lending reservation time period in the storage unit 11.

The lending management device 10 requests the authentication device 20 so that the authentication information of a user is registered for only the lending reservation time period. For example, at the start of the lending reservation time period, the lending management device 10 requests the authentication device 20 to register the authentication information of a user. In addition, at the end of the lending reservation time, the lending management device 10 requests the authentication device 20 to delete the registered authentication information of a user. In addition, the authentication information whose registration has been requested is stored in an authentication information storage unit 21 included in the authentication device 20.

The information processing device 3 transmits the authentication information of a user to the authentication device 20, and requests the permission of an operation.

In response to the request from the lending management device 10, the authentication device 20 causes the authentication information storage unit 21 to store therein the authentication information of a user serving as the lending destination of the information processing device 3. In addition, when the authentication information of a user, transmitted from the information processing device 3, has been stored in the authentication information storage unit 21, the authentication device 20 permits the operation of the information processing device 3.

Here, a case will be described where the information processing device 3 is lent to a user 4 for a lending reservation time period of “February 2nd, 10 o'clock to 12 o'clock”. In addition, in the storage unit 11 in the lending management device 10, a user ID, “USER1”, and a password, “PASS1”, have been stored as the authentication information of the user 4. In addition, it is assumed that the user 4 who have made a lending reservation has been notified of the user ID, “USER1”, and the password, “PASS1”.

In this case, when it comes to “10 o'clock” that is the start time of the lending reservation time period, the lending management device 10 requests the authentication device 20 to register, in the authentication information storage unit 21, the authentication information of the user 4 where the user ID is “USER1” and the password is “PASS1”. The authentication device 20 registers the authentication information of the user 4 (step S1). In addition, when it comes to “12 o'clock” that is the end time of the lending reservation time period, the lending management device 10 requests the authentication device 20 to delete that registered authentication information (step S2). Owing to this, the authentication information of the user 4 is stored in the authentication information storage unit 21 in the authentication device 20 for only 10 o'clock to 12 o'clock that is the lending reservation time period.

On the other hand, the user 4 inputs, to the information processing device 3, the authentication information given notice of by the lending management device 10 (step S3). The information processing device 3 transmits, to the authentication device 20, the authentication information input by the user 4, and requests authentication (step S4).

When having received the authentication request from the information processing device 3, the authentication device 20 judges whether the received authentication information has been stored in the authentication information storage unit 21. Here, if a timing when the authentication device 20 has received the authentication request falls within the lending reservation time period, the received authentication information has been stored in the authentication information storage unit 21. In this case, the authentication device 20 permits the operation of the information processing device 3 (step S5). Owing to this, the operation of the information processing device 3 is started, and it becomes possible for the user 4 to use the information processing device 3.

However, if a timing when the authentication device 20 has received the authentication request falls outside the lending reservation time period, (for example, before 10 o'clock or after 12 o'clock), the received authentication information has not been stored in the authentication information storage unit 21. In this case, since the authentication device 20 does not permit the operation of the information processing device 3, it is difficult for the user 4 to use the information processing device 3.

According to the above-mentioned processing, it is possible to restrict the usable time period of the information processing device 3 by the user 4, to the lending reservation time period stored in the storage unit 11. For example, even if the information processing device 3 has been lent to the user 4 before the start of the lending reservation time period, it is difficult for the user 4 to use the information processing device 3 until the lending reservation time period is started.

In addition, even if an authentication function for a user to use the information processing device 3 is not provided on the lending management device 10 side, it is possible to realize usage time period restriction for the information processing device 3 in such a way as described above. Therefore, it may be possible to reduce the development cost or the introduction cost of the lending management device 10. In addition, as the authentication device 20, for example, an existing device such as a server realizing a directory service may also be used. Accordingly, it may be possible to reduce the development cost or the introduction cost of the whole system.

In addition, while, in the above-mentioned example, it is assumed that the authentication information is notified to the user 4, the authentication information may also be, for example, preliminarily stored in the information processing device 3. In this case, for example, at the time of startup, the information processing device 3 automatically transmits, to the authentication device 20, authentication information the information processing device 3 itself holds, and requests the permission of an operation. According to such processing, it becomes possible to restrict a time period for which a specific information processing device 3 is usable.

### Second Embodiment

Next, a lending reservation system will be described in which the usage time period of a lent information processing device is restricted and an individual piece of a lent information processing device is also restricted. In addition, here, as an example, a case will be assumed in which an information processing device is lent to an employee within a company.

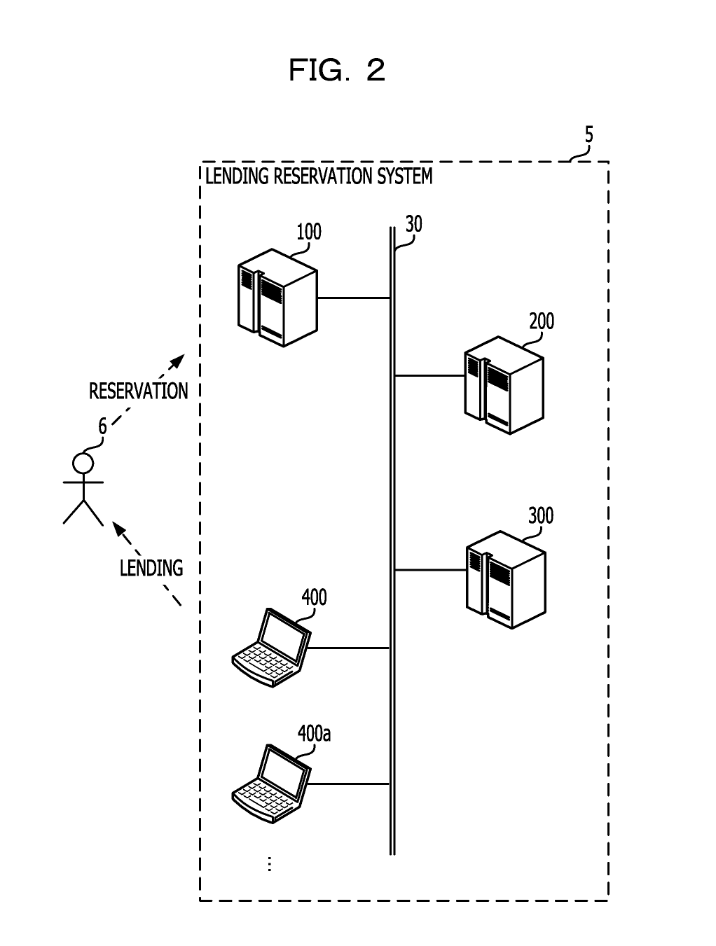

FIG. 2 is a diagram illustrating an example of the configuration of a lending reservation system of a second embodiment. A lending reservation system 5 includes a lending reservation device 100, a domain controller 200, a file server 300, and an information processing device 400. From among these devices, the information processing device 400 is a device serving as a target of lending to a user, and, for example, a plurality of the information processing devices 400 are prepared. The lending reservation device 100, the domain controller 200, the file server 300, and the information processing devices 400, 400a, . . . are coupled to one another through a network 30.

The lending reservation device 100 is a computer managing the lending of the information processing device 400. The lending reservation device 100 receives a lending reservation for the information processing device from a user 6. Information relating to the lending reservation includes a lending time period, information relating to a display folder, and so forth.

The display folder is a folder displayed in the screen of the information processing device when the operation of the information processing device has been permitted. In the present embodiment, the display folder is a shared folder shared by a plurality of users belonging to the same department. In addition, a function for causing such a display folder to be displayed is realized by storing information relating to the display folder, in the file server 300. The detail thereof will be described later. In addition, such a function may also be realized by a function in the “ACTIVE DIRECTORY” of Microsoft, which is called Roaming User Profile.

The lending reservation device 100 notifies the user 6 who made a reservation of login information including a user ID and a password.

In addition, on the basis of the login information, the lending reservation device 100 generates authentication information to be registered in the domain controller 200. The lending reservation device 100 requests the domain controller 200 so that the authentication information of the user 6 is registered for only a reserved lending time period. In the present embodiment, as an example, the lending reservation device 100 requests the domain controller 200 to register the authentication information of the user 6 a predetermined time before the start time of the lending time period (hereinafter, referred to as a lending start time). After that, when it is past the end time of the lending time period (hereinafter, referred to as a lending end time), the lending reservation device 100 requests the domain controller 200 to delete the authentication information of the user 6.

In addition, the lending reservation device 100 performs control so that the information relating to the display folder is stored in the file server 300 for only the lending time period where the lending reservation has been made.

The file server 300 is a server used for storage of data or a setting relating to the display folder. The file server 300 provides a storage area expressed by the display folder. In addition, the file server 300 stores therein the display folder and information relating to the access authority of the display folder. When permission to access the display folder has been requested, the file server 300 judges, on the basis of the presence or absence of authority to access the display folder, whether an access is permitted, and gives notice of a judgment result.

The information processing device 400 is a computer lent to the user 6. The information processing device 400 may also be a portable computer such as a notebook-sized PC, and may also be a computer placed in a predetermined location in the same manner as a desktop PC. When having been started up, the information processing device 400 requests a user to input login information, and when having received the input of the login information, the information processing device 400 generates authentication information on the basis of the login information and the media access control (MAC) address of the information processing device 400. The information processing device 400 transmits the generated authentication information to the domain controller 200, and requests authentication. When the domain controller 200 has succeeded in the authentication of the user 6, the information processing device 400 is permitted to operate. At that time, the information processing device 400 receives information relating to the display folder from the domain controller 200.

In addition, on the basis of the received information relating to the display folder, the information processing device 400 requests the file server 300 to permit an access to the display folder. When an access to the display folder has been permitted by the file server 300, the information processing device 400 displays the display folder on a screen. At this time, it becomes possible for the information processing device 400 to access a storage area corresponding to the display folder.

The domain controller 200 is a server managing devices coupled to the network 30, environments within the devices, and users utilizing these devices. For example, it is possible to realize the domain controller 200, using a server device playing a role in an authentication function for a user, from among devices used for realizing a directory service.

In response to the request of the lending reservation device 100, the domain controller 200 puts into a state where the authentication information of the user 6 is registered for only the lending time period.

In addition, the domain controller 200 has a function for authenticating a user on the basis of the authentication information received from the information processing device 400, in response to a request from the information processing device 400. When having succeeded in the authentication of the user, the domain controller 200 permits the operation of the information processing device 400, and notifies the information processing device 400 of the information relating to the display folder.

In addition, in the lending reservation system 5, a function may also be realized in the following way, the function being used for causing the authentication information of the user 6 to be registered in the domain controller 200 for only the lending time period. First, the lending reservation device 100 transmits, to the domain controller 200, the authentication information of the user 6 and the lending time period. The domain controller 200 performs control so that the authentication information of the user 6 is registered for only the received lending time period.

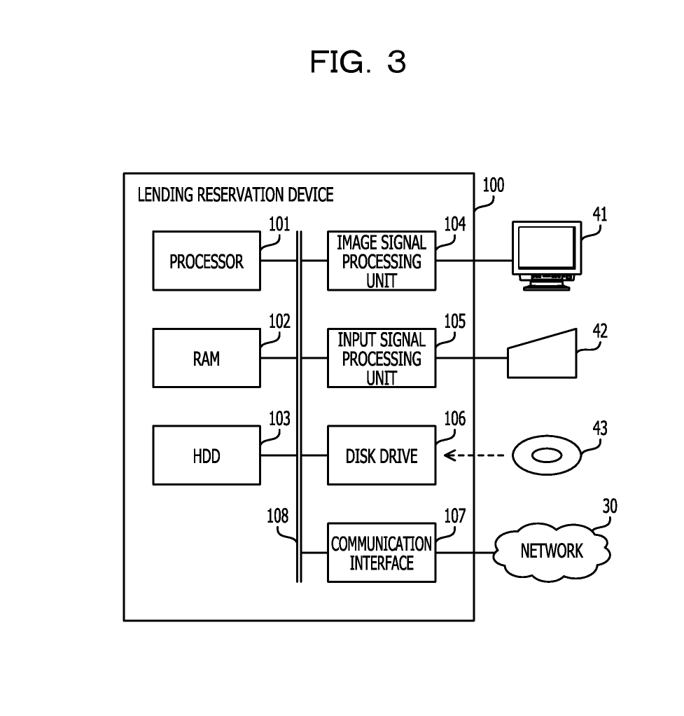

FIG. 3 is a diagram illustrating an example of the hardware configuration of a lending reservation device. The lending reservation device 100 includes a processor 101, a random access memory (RAM) 102, a hard disk drive (HDD) 103, an image signal processing unit 104, an input signal processing unit 105, a disk drive 106, and a communication interface 107. These units are coupled to a bus 108 within the lending reservation device 100.

The processor 101 is a processor including an arithmetic unit executing the instructions of a program. The processor 101 loads at least a portion of a program and data stored in the HDD 103 into the RAM 102, and executes the program. In addition, the processor 101 may also include a plurality of processor cores. In addition, the lending reservation device 100 may also include a plurality of processors. In addition, the lending reservation device 100 may also perform parallel processing using a plurality of processors or a plurality of processor cores. In addition, in the present specification, a set of two or more processors, a dedicated circuit such as a field programmable gate array (FPGA) or an application specific integrated circuit (ASIC), a set of two or more dedicated circuits, and the combination of a processor and a dedicated circuit are also called processors.

The RAM 102 is a volatile memory temporarily storing therein a program executed by the processor 101 or data referenced from the program. In addition, the lending reservation device 100 may also include a type of memory other than the RAM, and may also include a plurality of volatile memories.

The HDD 103 is a non-volatile storage device storing therein the programs and the data of pieces of software such as an operating system (OS), firmware, and application software. In addition, the lending reservation device 100 may also include another type of storage device such as a flash memory, and may also include a plurality of non-volatile storage devices.

In accordance with an instruction from the processor 101, the image signal processing unit 104 outputs an image to a display 41 coupled to the lending reservation device 100. As the display 41, a cathode ray tube (CRT) display, a liquid crystal display, or the like may be used.

The input signal processing unit 105 acquires an input signal from an input device 42 coupled to the lending reservation device 100, and notifies the processor 101 of the input signal. As the input device 42, a pointing device such as a mouse or a touch panel, a keyboard, or the like may be used.

The disk drive 106 is a drive device reading a program or data recorded in a recording medium 43. As the recording medium 43, for example, a magnetic disk such as a flexible disk (FD) or an HDD, an optical disk such as a compact disc (CD) or a digital versatile disc (DVD), or a magneto-optical disk (MO) may be used. In accordance with an instruction from the processor 101, the disk drive 106 stores, in the RAM 102 or the HDD 103, the program or the data read from the recording medium 43.

Through a network such as the network 30, the communication interface 107 communicates with another information processing device, for example, the domain controller 200 or the like.

In addition, the lending reservation device 100 may not include the disk drive 106, and when having been mainly accessed from another information processing device, the lending reservation device 100 may not include the image signal processing unit 104 and the input signal processing unit 105. In addition, the display 41 or the input device 42 may also be formed to be integrated with the chassis of the lending reservation device 100.

In addition, the domain controller 200, the file server 300, and the information processing devices 400 and 400a may also be realized using the same hardware as the lending reservation device 100.

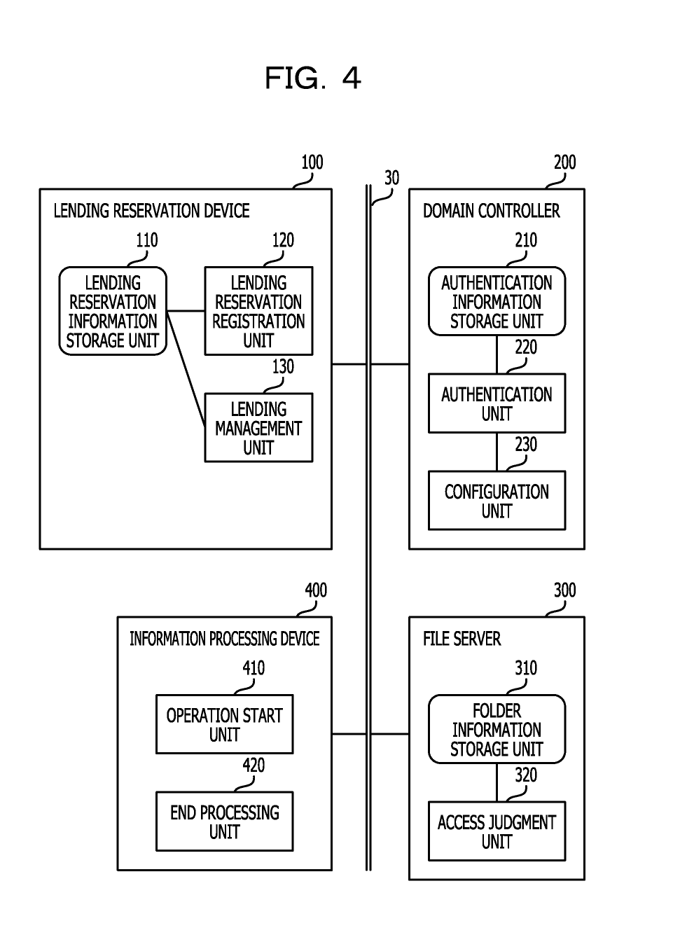

FIG. 4 is a diagram illustrating an example of the function of a lending reservation system. The lending reservation device 100 includes a lending reservation information storage unit 110, a lending reservation registration unit 120, and a lending management unit 130.

The lending reservation information storage unit 110 stores, in a lending reservation table, information relating to a lending reservation for an information processing device. The information relating to the lending reservation includes, for example, pieces of information such as a lending start time, a lending end time, a lending time period, a place to which the user 6 who made a reservation belongs, the device name of an information processing device, and a display folder. In addition, the lending reservation information storage unit 110 stores therein a MAC address table storing therein information in which the device name of an information processing device and a MAC address are associated with each other.

The lending reservation registration unit 120 registers, in a lending reservation table, information relating to a lending reservation input by the user 6. In addition, the lending reservation registration unit 120 generates login information including a user ID and a password, and registers the login information in the lending reservation table. The user ID is generated on the basis of information stored in the lending reservation table, and the password is generated randomly. In addition, the lending reservation registration unit 120 notifies the user 6 of the generated login information.

When it is past a time preceding the lending start time by a predetermined time, the lending management unit 130 transmits, to the domain controller 200, a registration request for the authentication information of the user 6, and stores information relating to the display folder in the file server 300. The authentication information includes an authentication ID and a password. The authentication ID is generated on the basis of the lending reservation table and the MAC address table. The password is acquired from the lending reservation table.

In addition, when it is past a time preceding the lending end time by a predetermined time, the lending management unit 130 transmits a lending-end preliminary announcement notice to the information processing device 400. In addition, when it comes to the lending end time, the lending management unit 130 transmits a shutdown request to the information processing device 400, and transmits an authentication information deletion request to the domain controller 200. Furthermore, the lending management unit 130 deletes the information relating to the display folder from the file server 300.

The file server 300 includes a folder information storage unit 310 and an access judgment unit 320. The folder information storage unit 310 stores therein a display folder table storing therein information in which the authentication ID of the user and the information relating to the display folder are associated with each other. In addition, the folder information storage unit 310 stores therein an affiliation table storing therein information where a place to which the user 6 belongs and access authority are associated with each other. Furthermore, the folder information storage unit 310 stores therein an authority information table storing therein information relating to authority to access the display folder.

The access judgment unit 320 receives an access permission request from the information processing device 400. On the basis of the place to which the user 6 who made a reservation belongs, the affiliation table, and the authority information table, the access judgment unit 320 judges whether the user 6 has the authority to access the display folder. In addition, the access judgment unit 320 transmits a judgment result to the information processing device 400.

The information processing device 400 includes an operation start unit 410 and an end processing unit 420.

On the basis of the login information whose input has been received from the user 6, the operation start unit 410 generates authentication information to be transmitted to the domain controller 200. The authentication information includes an authentication ID and a password. The authentication ID is generated on the basis of the user ID of the input login information and the MAC address of the information processing device 400. The operation start unit 410 transmits, to the domain controller 200, an authentication request including the generated authentication information. When having received an operation permission notice from the domain controller 200, the operation start unit 410 permits the operation of the information processing device 400. At that time, the operation start unit 410 receives, from the domain controller 200, the information relating to the display folder.

On the basis of the received information relating to the display folder, the operation start unit 410 transmits, to the file server 300, a request to permit an access to the display folder. When having received, from the file server 300, a notice of permission of an access to the display folder, the operation start unit 410 displays the display folder on the display 41.

When having received a lending-end preliminary announcement notice from the lending reservation device 100, the end processing unit 420 performs display on a screen to that effect. In addition, when having received a shutdown request from the lending reservation device 100, the end processing unit 420 shuts down the information processing device 400.

The domain controller 200 includes an authentication information storage unit 210, an authentication unit 220, and a configuration unit 230.

The authentication information storage unit 210 stores therein an authentication table storing therein the authentication information of a user who utilizes an information processing device.

When having received an authentication information registration request from the lending reservation device 100, the authentication unit 220 registers the authentication information of a user in the authentication table. When having received an authentication information deletion request from the lending reservation device 100, the authentication unit 220 deletes the authentication information of a user from the authentication table. When having received an authentication request from the information processing device 400, the authentication unit 220 authenticates the user to utilize the information processing device 400, on the basis of authentication information included in the authentication request and the authentication table.

When having succeeded in the authentication of the user, the configuration unit 230 acquires, from the file server 300, the information relating to the display folder. In addition, the configuration unit 230 transmits, to the information processing device 400, an operation permission notice including the acquired information relating to the display folder.

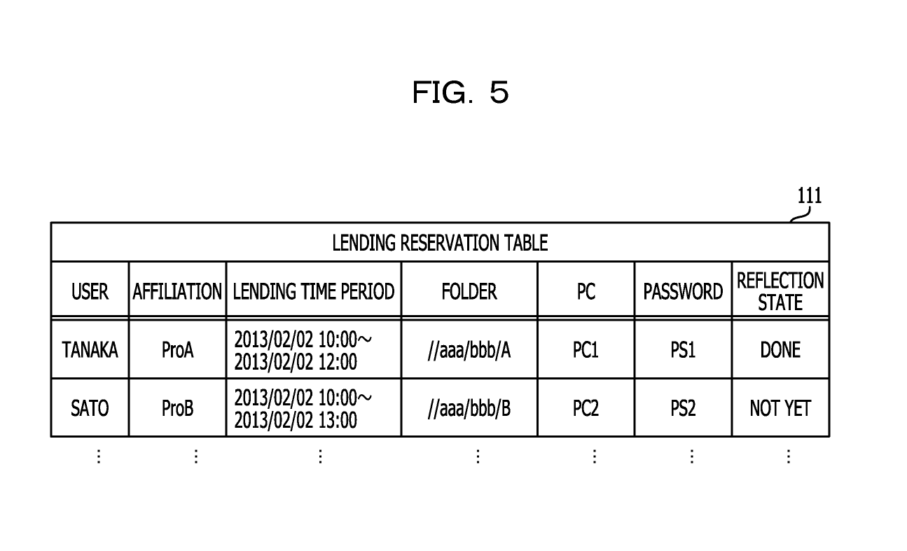

Next, using FIG. 5 to FIG. 10, examples of pieces of table information used in the lending reservation system 5 will be described.

FIG. 5 is a diagram illustrating an example of a lending reservation table. A lending reservation table 111 stores therein information relating to a lending reservation for an information processing device. The lending reservation table 111 includes the items of a user, affiliation, a lending time period, a folder, a PC, a password, and a reflection state.

In the item of the user, the name of a user who made a reservation for the lending of the information processing device 400 is set.

In the item of the affiliation, a place to which the user who made a reservation for the lending belongs is set.

In the item of the lending time period, the lending time period of the reserved information processing device is set. The lending time period includes a lending start time and a lending end time.

In the item of the folder, information relating to a display folder is set. The display folder is displayed on the display 41 when the operation of the information processing device 400 has been permitted by the domain controller 200. The information relating to a display folder includes the path information of the display folder. In addition, the information relating to a display folder may also include information indicating the display location of the display folder in the information processing device 400. As the display location, for example, a desktop, a taskbar in Windows (registered trademark), or the like may be cited.

In the item of the PC, an identifier is set that identifies the device of the information processing device whose lending has been reserved.

In the item of the password, the password of the user who made a reservation is set. When the user has made a reservation, the password is randomly generated by the lending reservation registration unit 120.

In the item of the reflection state, information is set that indicates whether information relating to a lending reservation has been reflected to the domain controller 200 or the file server 300. For example, when the information of the record of the lending reservation table 111 has been reflected, “done” is set in the item of the reflection state. When the information of the record of the lending reservation table 111 has not been reflected, “not yet” is set in the item of the reflection state.

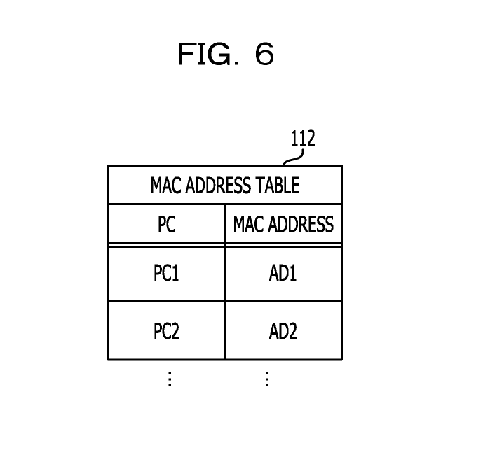

FIG. 6 is a diagram illustrating an example of a MAC address table. A MAC address table 112 stores therein information in which the device name and the MAC address of an information processing device are associated with each other. The MAC address table 112 is preliminarily stored in the lending reservation information storage unit 110.

The MAC address table 112 includes the items of a PC and a MAC address. In the item of the PC, an identifier is set that identifies an information processing device to serve as a lending target. In the item of the MAC address, the MAC address of the information processing device is set.

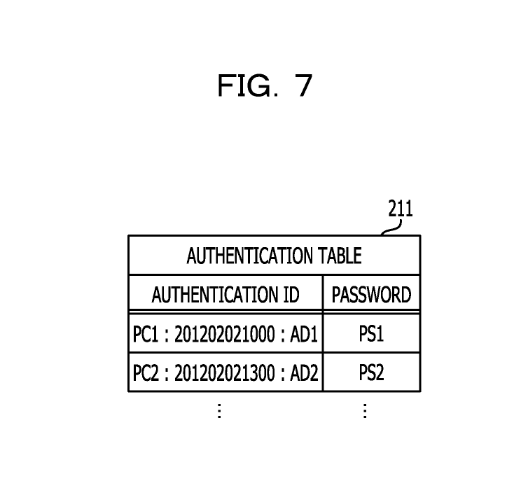

FIG. 7 is a diagram illustrating an example of an authentication table. An authentication table 211 stores therein the authentication information of a user to utilize a lent information processing device. The authentication table 211 is stored in the authentication information storage unit 210 by the authentication unit 220 that has received an authentication information registration request from the information processing device.

The authentication table 211 includes the items of an authentication ID and a password. In the item of the authentication ID, an identifier is set that is used for authenticating a user who reserved an information processing device. In the item of the password, a password is set that is used for authenticating a user who reserved an information processing device.

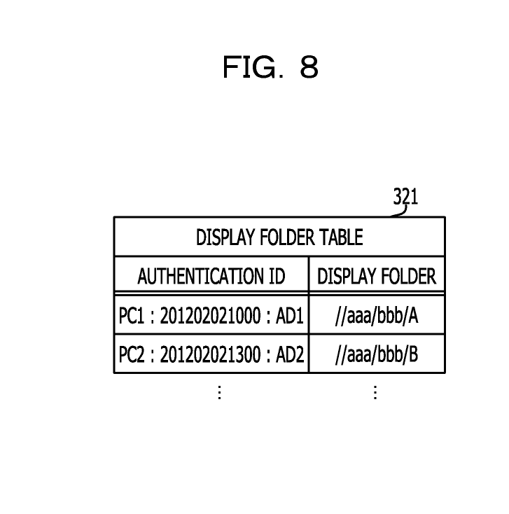

FIG. 8 is a diagram illustrating an example of a display folder table. A display folder table 321 stores therein information in which the authentication ID of the user 6 and information relating to a display folder are associated with each other. The display folder table 321 is stored in the folder information storage unit 310 by the lending management unit 130.

The display folder table 321 includes the items of an authentication ID and a display folder. In the item of the authentication ID, an identifier is set that is used for authenticating a user who reserved an information processing device. In the item of the display folder, the path information of a display folder is set that is to be displayed on the display of a lent information processing device when the information processing device has received the input of login information. In addition, the item of the display folder may also include information indicating the display destination of the display folder, for example, a desktop or the like.

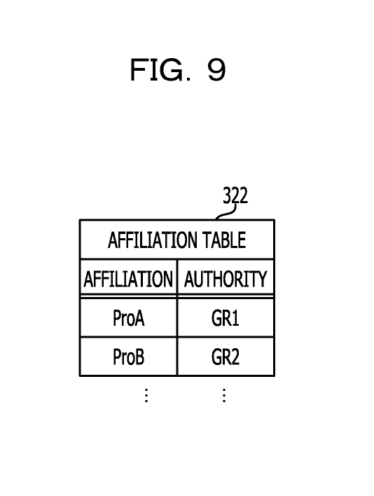

FIG. 9 is a diagram illustrating an example of an affiliation table. An affiliation table 322 stores therein information where a place to which a user belongs in a company and access authority are associated with each other. The affiliation table 322 is preliminarily stored in the folder information storage unit 310.

The affiliation table 322 includes the items of affiliation and authority. In the item of the affiliation, information is set that indicates the affiliation destination of a user, the affiliation destination being managed by the lending reservation system 5. In the item of the authority, information is set that indicates the type of access authority corresponding to the affiliation destination of a user. In addition, an affiliation destination and the type of authority may not be on a one-to-one basis, and, for example, one type of authority may also be associated with a plurality of affiliation destinations.

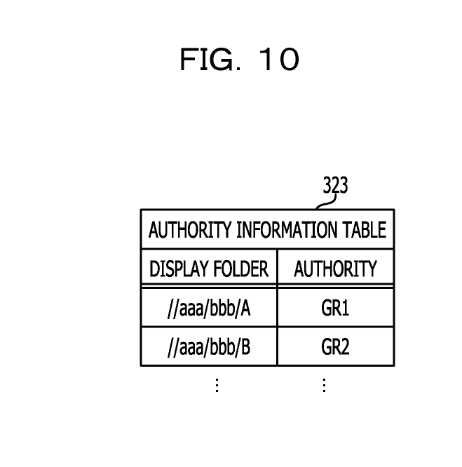

FIG. 10 is a diagram illustrating an example of an authority information table. An authority information table 323 stores therein information relating to authority to access a display folder. The authority information table 323 is preliminarily stored in the folder information storage unit 310.

The authority information table 323 includes the items of a display folder and authority. In the item of the display folder, the path information of a display folder is set. In the item of the authority, information is set that indicates the type of access authority corresponding to an affiliation destination capable of accessing a display folder.

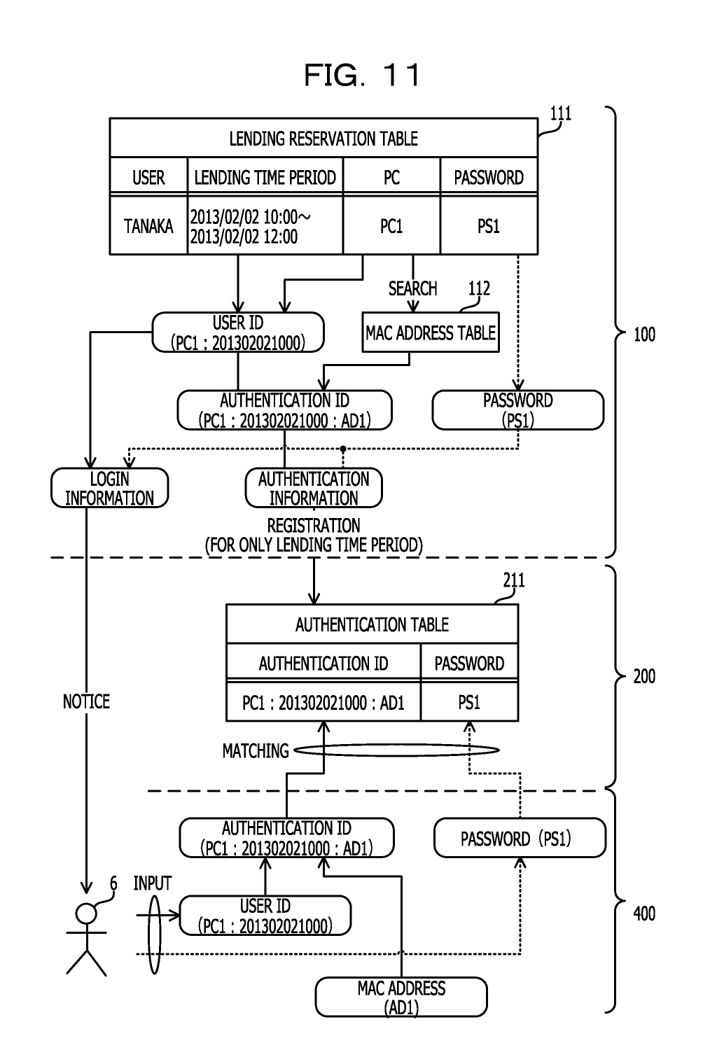

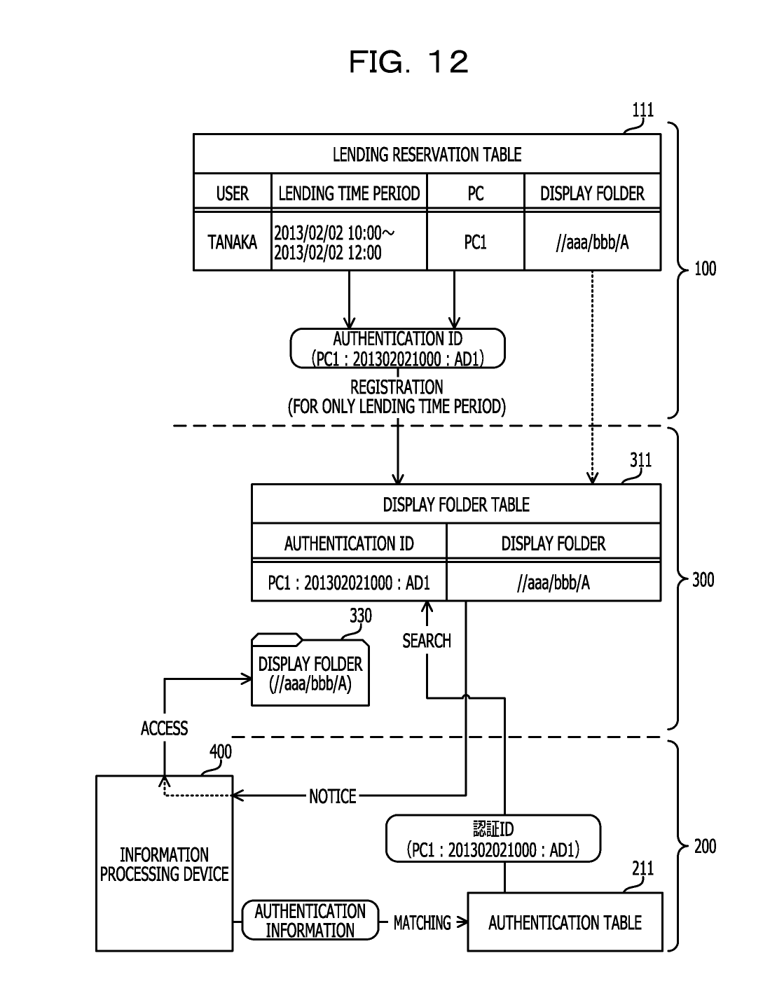

Next, using FIG. 11 and FIG. 12, main processing will be described that is performed in the lending reservation system 5.

FIG. 11 is a diagram for explaining processing for restricting a usable time period of an information processing device and an individual piece of an information processing device to be used.

When the user 6 has input, to the lending reservation device 100, information relating to a lending reservation for the information processing device 400, one record is registered in the lending reservation table 111 in the lending reservation device 100. In addition, in FIG. 11, in the lending reservation table 111, the description of the items of the affiliation, the display folder, and the reflection state is omitted.

The lending reservation device 100 generates login information to be input to the information processing device 400 to be lent, and notifies the user 6 of the login information. The login information notified to the user 6 includes a user ID and a password. The user ID is generated on the basis of the items of the PC and the lending time period in the lending reservation table 111.

For example, it is assumed that, in the lending reservation table 111, “PC1” is set in the item of the PC corresponding to the user 6 and “2013/02/02 10:00” is set in a start time in the item of the lending time period. In this case, as the user ID, for example, “PC1:201302021000” is generated that is obtained by combining pieces of information set in these items. As the password, a password randomly generated and registered is acquired from the lending reservation table 111.

On the other hand, authentication information registered in the authentication table 211 in the domain controller 200 by the lending reservation device 100 includes an authentication ID and a password. The authentication ID is generated on the basis of the lending reservation table 111 and the MAC address table 112.

Specifically, first, “PC1” set in the item of the PC is read from lending reservation table 111. Next, a record is searched for from the MAC address table 112 where the item of the PC coincides with the read “PC1”. In addition, information obtained by adding a value, set in the MAC address of the record searched for, to a user ID, “PC1:201302021000”, for example, “PC1:201302021000:AD1”, is generated as an authentication ID. The password is acquired from the lending reservation table 111 in the same way as the login information.

The lending reservation device 100 registers the generated authentication information in the authentication table 211 in the domain controller 200 a predetermined time before a lending start time. In addition, when it comes to a lending end time, the lending reservation device 100 deletes the authentication information from the authentication table 211 in the domain controller 200. In other words, the generated authentication information is put into a state of being registered in the authentication table 211 for only a reserved lending time period.

On the other hand, when having activated the power supply of the rent information processing device 400, the user 6 notified of the login information is requested to input the login information. When the user 6 has input the login information, the information processing device 400 adds the MAC address of the self-device to the input user ID, and generates an authentication ID, “PC1:201302021000:AD1”. The information processing device 400 transmits the generated authentication ID and the input password to the domain controller 200, and requests the domain controller 200 to perform authentication.

The domain controller 200 matches the authentication ID and the password, received from the information processing device 400, to information within the authentication table 211. If the timing of the authentication request falls within the lending time period, the received authentication ID and password are registered in the authentication table 211. Therefore, the domain controller 200 succeeds in the authentication. In this case, the start-up of the information processing device 400 is permitted, and it becomes possible for the user 6 to use the lent information processing device 400.

On the other hand, the timing of the authentication request falls outside the lending time period, the received authentication ID and password are not registered in the authentication table 211. Therefore, the domain controller 200 fails in the authentication. In this case, it is difficult for the information processing device 400 to be started up, and it is difficult for the user 6 to use the lent information processing device 400.

In this way, the authentication information is registered in the authentication table 211 for only the lending time period, and hence, the usable time period of the lent information processing device 400, due to the user 6, is restricted to within the reserved lending time period.

In addition, for example, a case will be considered in which the user 6 uses an information processing device different from the reserved information processing device. In this case, when the user inputs login information to the information processing device, the information processing device generates an authentication ID by adding the MAC address of the self-device to an input user ID, and transmits this authentication ID to the domain controller 200 along with a password.

However, in this case, the MAC address of the information processing device the user uses is different from the MAC address of an information processing device to be normally lent to the user. Therefore, the authentication ID generated in the information processing device is not registered in the authentication table 211, and the domain controller 200 fails in authentication. Accordingly, it is difficult for the information processing device to be started up, and it is difficult for the user to use this information processing device.

In this way, information for identifying an individual piece of the information processing device is used for generating the authentication information, and hence, the lent information processing device is restricted to an intended one.

In addition, information added to the user ID so as to generate the authentication ID is not limited to the MAC address if the information is capable of identifying an individual piece of the information processing device.

FIG. 12 is a diagram for explaining processing for displaying a display folder in an information processing device whose use has been permitted.

When the operation of the information processing device 400 has been permitted by the domain controller 200, the information processing device 400 displays, on a screen, a folder registered in the lending reservation table 111. The display folder is a shared folder usable by a plurality of users belonging to the same department, and set on the file server 300. In other words, a storage area 330 corresponding to the display folder is realized by a storage device in the file server 300. For example, when a user belonging to a department has made a reservation for the first time, the setting of a display folder is performed, and after that, when an information processing device has been lent to another user belonging to the same department, it also becomes possible to use the same display folder.

The display of the display folder is performed in the following way. The lending reservation device 100 registers, in the display folder table 311, a generated authentication ID and the path information of a display folder registered in the lending reservation table 111. As described later, in the present embodiment, the authentication ID and the path information are registered in the display folder table 311 for only the lending time period.

The display folder table 311 is stored in a preliminarily defined storage area to be referenced by the domain controller 200 at the time of the success of user authentication. In the present embodiment, the display folder table 311 is stored in the file server 300. In addition, while not illustrated, information is preliminarily stored in a storage device in the domain controller 200, the information indicating an area to be referenced at the time of the success of user authentication.

When having succeeded in the authentication of the authentication information transmitted from the information processing device 400 in accordance with the procedure illustrated in FIG. 11, the domain controller 200 searches for a record in which the received authentication ID is registered, from the display folder table 311. The domain controller 200 reads the path information of a display folder, stored in the record searched for, and notifies the information processing device 400 of the path information. Owing to this, the information processing device 400 displays the display folder corresponding to the path information given notice of, on a display screen, and it becomes possible to access the storage area 330 indicated by the path information given notice of.

In addition, for example, when notifying the path information of the display folder of the information processing device 400, the domain controller 200 may also transmit, to the information processing device 400, information that is called a “ticket” and indicates the success of authentication. In this case, when accessing the storage area 330 corresponding to the display folder, the information processing device 400 transmits a ticket to the file server 300. On the basis of the information of the received ticket, the file server 300 judges that the access is an access from the already authenticated information processing device 400, and permits the access.

Here, as described above, in the present embodiment, the authentication ID and the path information of the display folder are registered in the display folder table 311 for only the reserved lending time period. In other words, the lending reservation device 100 registers, in the display folder table 311, the authentication ID and the path information a predetermined time before the lending start time. In addition, when it comes to the lending end time, the lending reservation device 100 deletes the authentication ID and the path information from the display folder table 311. Owing to this, the display folder becomes available for the user for only the reserved lending time period, and it may be possible to enhance the security of information stored in the storage area 330 corresponding to the display folder.

In addition, as described later, at the time of the access of the information processing device 400 to the display folder, authentication according to the affiliation destination name of the user is further executed.

In addition, the authentication ID and the path information of the display folder may be registered in the display folder table 311 within at least the lending time period. For example, when a reservation due to the user 6 has been made and a corresponding record has been registered in the lending reservation table 111, the authentication ID and the path information of the display folder may also be registered in the display folder table 311. In this regard, however, by the authentication ID and the path information of the display folder being registered in the display folder table 311 for only the lending time period, it may be possible to precisely restrict the usable time period of the display folder, and it may be possible to enhance the security of data stored in the corresponding storage area 330.

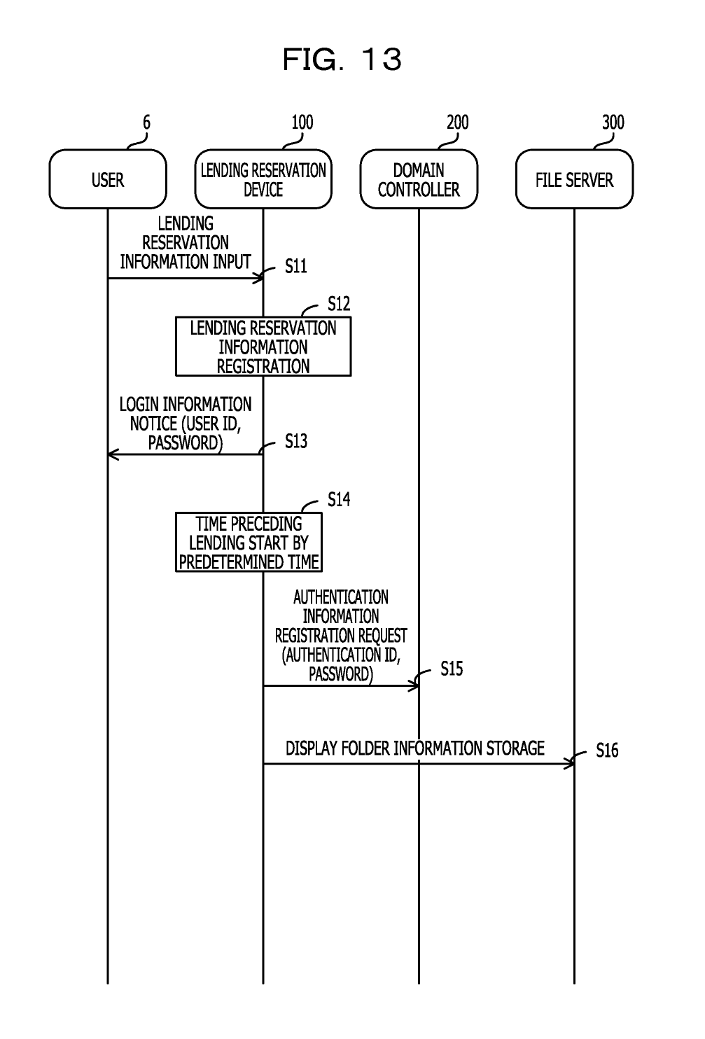

Next, using FIG. 13 to FIG. 15, the operations of individual devices will be described that range from when the user 6 reserves the lending of the information processing device 400 to when a lending time period for the user 6 ends.

FIG. 13 is a sequence illustrating examples of a lending reservation and a lending start.

In a step S11, the user 6 inputs, to the lending reservation device 100, information relating to a lending reservation for the information processing device 400. The lending reservation device 100 receives the input of the information relating to the lending reservation.

In addition, for example, owing to an input operation performed on a terminal device not illustrated, the user 6 inputs, to the lending reservation device 100, the information relating to the lending reservation. Alternatively, the information relating to the lending reservation may also be input to the lending reservation device 100 by an operator of the lending reservation device 100.

In a step S12, the lending reservation device 100 registers, in the lending reservation table 111, the input information relating to the lending reservation.

In a step S13, the lending reservation device 100 generates login information including a user ID and a password, and notifies the user 6 of the generated login information. As described above, the user ID is generated on the basis of the device name of the information processing device 400 and the lending reservation time period. These pieces of information are included in the registered information relating to the lending reservation. In addition, the password is generated randomly.

In a step S14, with respect to the reserved information processing device 400, the lending reservation device 100 confirms that it is past a time preceding the lending start time by a predetermined time, for example, a time preceding by 15 minutes.

In a step S15, the lending reservation device 100 generates the authentication information of the user 6. As described above, the authentication information includes the authentication ID and the password. The authentication ID is generated by adding the MAC address of the information processing device 400 to the user ID. The user ID includes the device name of the information processing device 400, registered in the step S12, and the lending time period registered in the step S12. The password is read from the password registered in the step S12. The lending reservation device 100 transmits, to the domain controller 200, an authentication information registration request including the generated authentication information. The authentication unit 220 in the domain controller 200 having received the authentication information registration request registers, in the authentication table 211, the authentication information included in the authentication information registration request.

In a step S16, the lending reservation device 100 stores, in the display folder table 321, information relating to a display folder, registered in the step S12, along with the authentication ID.

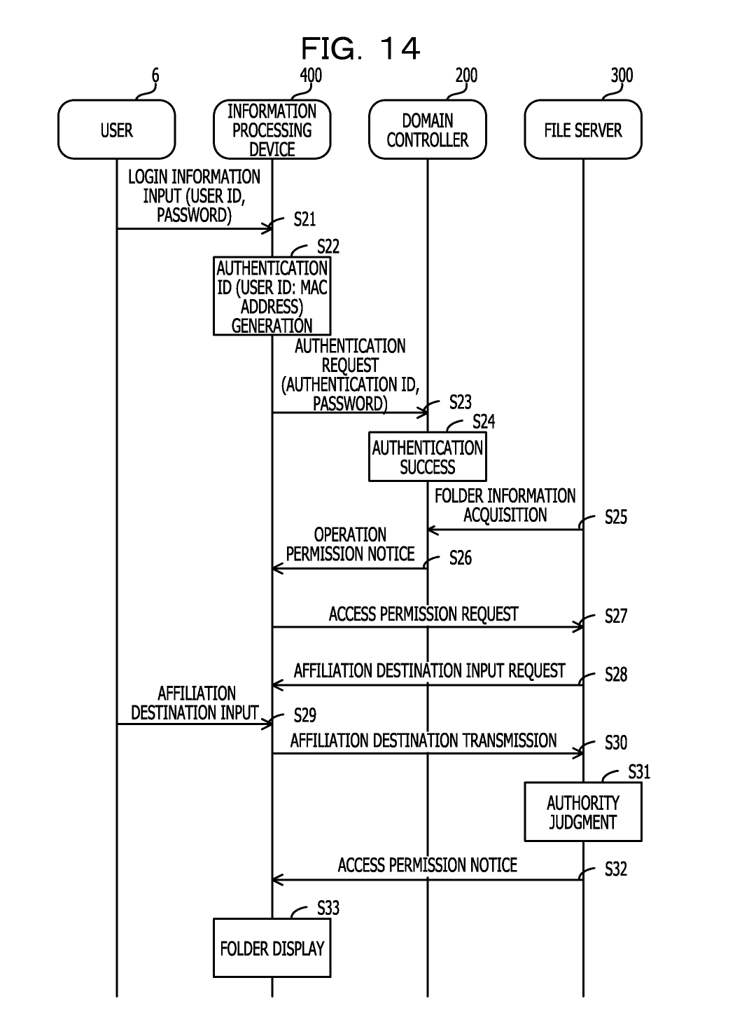

FIG. 14 is a sequence illustrating an example of use of an information processing device.

In a step S21, the user 6 activates the power supply of the rent information processing device 400. In the middle of start-up processing, the information processing device 400 requests to input login information. The user 6 inputs, to the information processing device 400, the login information given notice of in the step S13 in FIG. 13.

In a step S22, the information processing device 400 adds the MAC address of the information processing device 400 to the user ID included in the input login information, and generates an authentication ID.

In a step S23, the information processing device 400 transmits, to the domain controller 200, an authentication request including authentication information. The authentication information includes information indicating the generated authentication ID and a password. The domain controller 200 receives the authentication request.

In a step S24, the authentication unit 220 in the domain controller 200 matches the authentication information included in the authentication request to the authentication table 211, and authenticates the user 6. In FIG. 14, it is assumed that the authentication has succeeded.

In a step S25, the configuration unit 230 in the domain controller 200 acquires, from the display folder table 321 in the file server 300, information relating to a display folder associated with the authentication ID.

In a step S26, the configuration unit 230 in the domain controller 200 transmits, to the information processing device 400, an operation permission notice including the acquired information relating to the display folder. The information processing device 400 receives the operation permission notice.

In a step S27, on the basis of the information relating to the display folder, included in the received operation permission notice, the information processing device 400 transmits, to the file server 300, an access permission request including the path information of the display folder. The file server 300 receives the access permission request.

In a step S28, the access judgment unit 320 in the file server 300 transmits, to the information processing device 400, an affiliation destination input request causing the user 6 to input an affiliation destination.

In a step S29, the user 6 inputs, to the information processing device 400, information indicating the affiliation destination of the user 6.

In a step S30, the information processing device 400 transmits, to the file server 300, information indicating the affiliation destination whose input has been received from the user 6.

In a step S31, on the basis of the affiliation table 322 and the authority information table 323, the access judgment unit 320 in the file server 300 judges whether the received affiliation destination has authority to access the display folder where the information processing device 400 has made an access request.

Specifically, the access judgment unit 320 searches for the information of authority corresponding to the received affiliation destination, from the affiliation table 322, and searches for authority corresponding to the path information of the display folder included in the access permission request, from the authority information table 323. Next, when the authority corresponding to the affiliation destination and the authority corresponding to the path information of the display folder coincide with each other, the access judgment unit 320 judges that there is access authority.

In FIG. 14, it is assumed that it has been judged that there is the access authority.

In a step S32, the access judgment unit 320 in the file server 300 transmits, to the information processing device 400, an access permission notice for the display folder. The information processing device 400 receives the access permission notice.

In addition, when, in the step S31, it has been judged that there is not the access authority, the access judgment unit 320 in the file server 300 gives notice to the effect to the information processing device 400. In this case, it is difficult for the information processing device 400 to access a storage area corresponding to the display folder.

In a step S33, the information processing device 400 causes the display folder to be displayed on the screen of the display 41 in the information processing device 400, for example, a desktop.

In the above-mentioned FIG. 14, owing to the processing operations in the steps S28 to S31, an access to the display folder is restricted by the authentication based on the information of the affiliation destination of the user, in addition to the authentication utilizing the authentication information due to the domain controller 200. Owing to this, it may be possible to enhance the security of data stored in a storage area corresponding to the display folder.

In addition, in the present embodiment, so as to enable to assign access authority for the same display folder to a plurality of affiliation destination departments, a configuration is adopted where an item called “authority” is provided and the presence or absence of access authority is judged using the affiliation table 322 and the authority information table 323. However, for example, when an affiliation destination department and a display folder are associated with each other on a one-to-one basis, it may also be possible to adopt a configuration where the presence or absence of access authority is judged using only one authority information table in which an affiliation and the path information of a display folder are associated with each other.

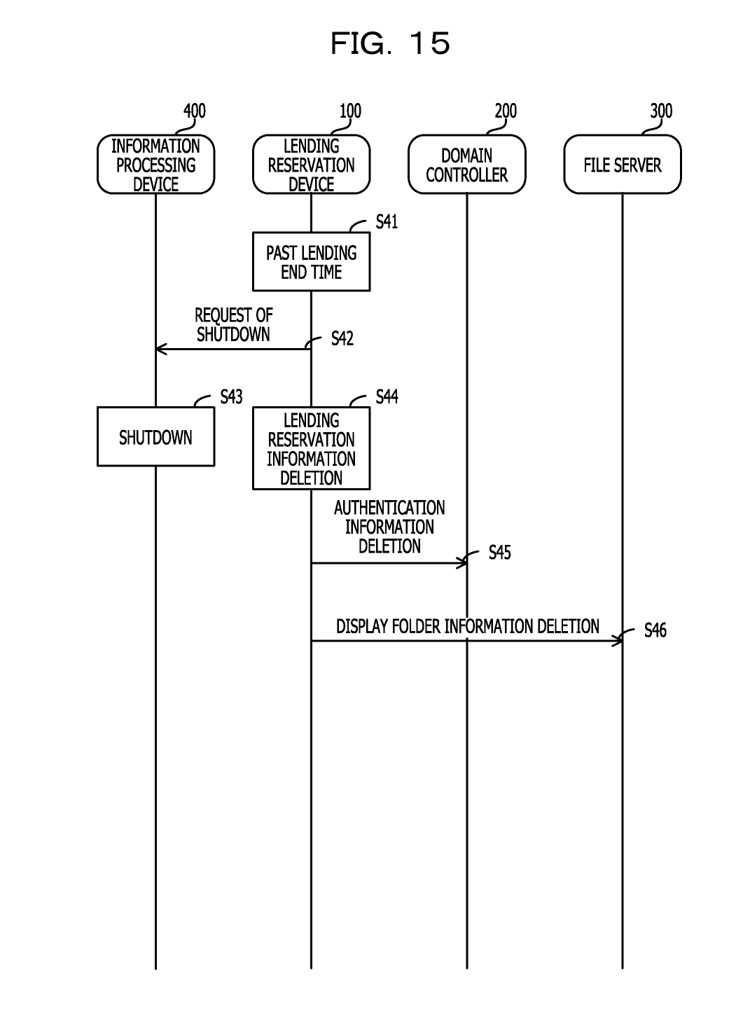

FIG. 15 is a sequence illustrating an example of an operation at the end of a lending time period.

In a step S41, the lending reservation device 100 confirms that it is past a lending end time.

In a step S42, the lending reservation device 100 transmits a shutdown request to the information processing device 400. The information processing device 400 receives the shutdown request.

In a step S43, the information processing device 400 is shut down.

In a step S44, the lending reservation device 100 deletes, from the lending reservation table 111, the record of a lending reservation where it is past the end time of the lending time period.

In a step S45, the lending reservation device 100 transmits, to the domain controller 200, a request to delete the authentication information of the user 6. The authentication unit 220 in the domain controller 200 having received the authentication information deletion request deletes, from the authentication table 211, authentication information included in the authentication information deletion request.

In a step S46, the lending reservation device 100 transmits a display folder information deletion request to the file server 300. The file server 300 deletes, from the display folder table 311, a record in which an authentication ID included in the display folder information deletion request is registered.

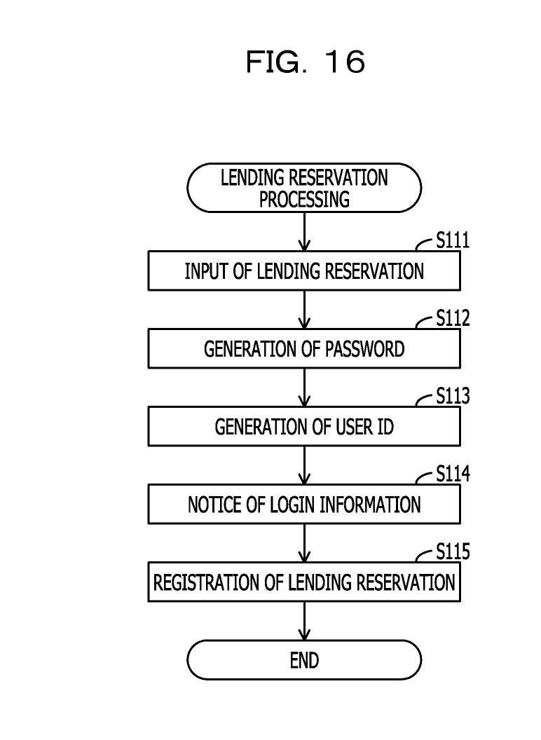

Next, using flowcharts in FIG. 16 to FIG. 20, processing operation procedures in the lending reservation system 5 will be described.

FIG. 16 is a flowchart illustrating an example of lending reservation processing. Hereinafter, the processing illustrated in FIG. 16 will be described along step numbers.

In a step S111, the lending reservation device 100 receives, from a user, the input of information relating to a lending reservation. The information relating to a lending reservation includes pieces of information such as a lending time period, the affiliation destination of a user, the device name of an information processing device 400 to be reserved, and a display folder.

In a step S112, the lending reservation registration unit 120 randomly generates a password.

In a step S113, the lending reservation registration unit 120 generates a user ID including the device name of the information processing device 400 and a lending start time, in the information relating to the lending reservation.

In a step S114, the lending reservation registration unit 120 notifies the user 6 of login information including the generated user ID and password.

In a step S115, the lending reservation registration unit 120 registers, in the lending reservation table 111, the information relating to the lending reservation.

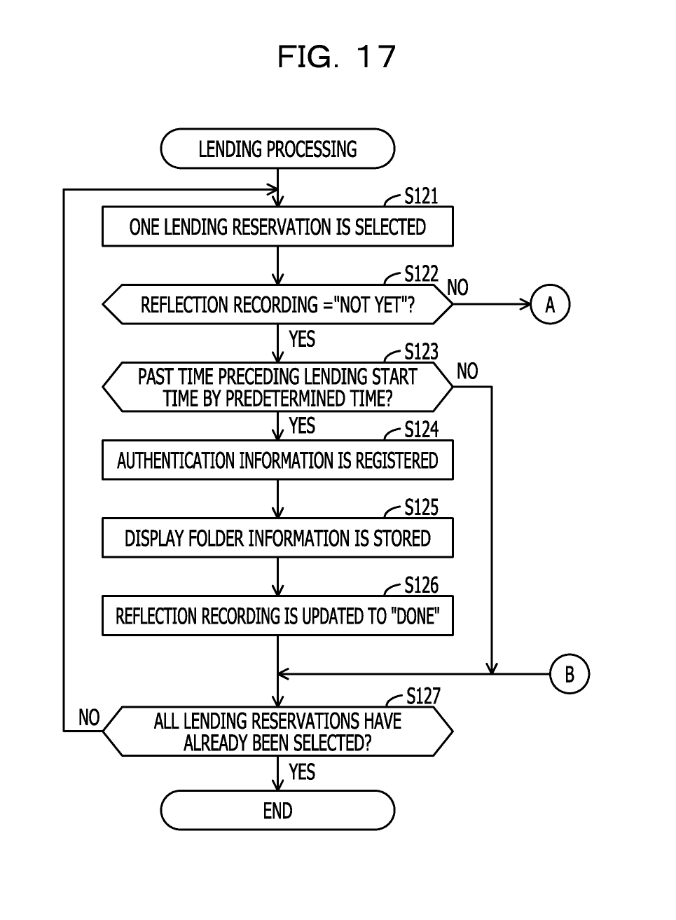

FIG. 17 is a first flowchart illustrating an example of lending processing. Hereinafter, the processing illustrated in FIG. 17 will be described along step numbers.

In a step S121, the lending management unit 130 selects one record of a lending reservation from the lending reservation table 111.

In a step S122, the lending management unit 130 judges whether reflection recording in the selected record is “not yet”. When the reflection recording is “not yet”, the processing is caused to proceed to a step S123. When the reflection recording is “done”, the processing is caused to proceed to a step S131

In the step S123, the lending management unit 130 judges whether it is past a time preceding a lending start time by a predetermined time, the lending start time being registered in the selected record. When it is past a time preceding a lending start time by a predetermined time, the processing is caused to proceed to a step S124. When it is not past a time preceding a lending start time by a predetermined time, the processing is caused to proceed to a step S127.

In the step S124, using information relating to a lending reservation or the like, registered in the selected record, the lending management unit 130 generates the authentication information of a user in accordance with the procedure described in FIG. 11. By transmitting, to the domain controller 200, an authentication information registration request including the generated authentication information, the lending management unit 130 registers the generated authentication information, in the authentication table 211 in the domain controller 200.

In a step S125, using the information relating to a lending reservation or the like, registered in the selected record, the lending management unit 130 generates information relating to a display folder in accordance with the procedure described in FIG. 12. The lending management unit 130 stores the generated information relating to a display folder, in the display folder table 321 in the file server 300.

In a step S126, in the lending reservation table 111, the lending management unit 130 updates, to “done”, reflection information in the selected record.

In the step S127, the lending management unit 130 judges whether all the records of lending reservations have been already selected. When all the records have been already selected, the processing is terminated. When a not-yet-selected lending reservation exists, the processing is caused to proceed to the step S121.

The above-mentioned processing in FIG. 17 is repeatedly executed every a given period of time.

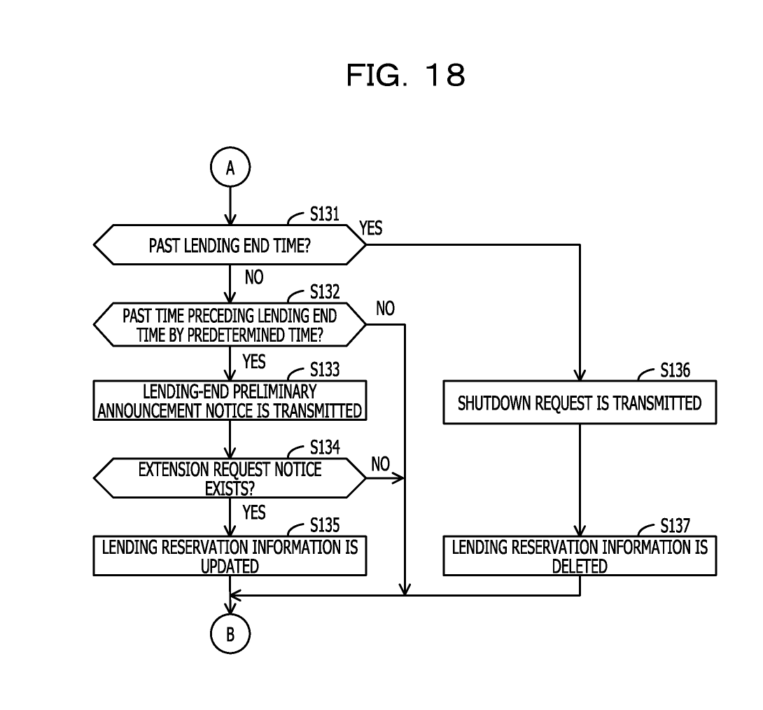

FIG. 18 is a second flowchart illustrating an example of lending processing. Hereinafter, the processing illustrated in FIG. 18 will be described along step numbers.

In a step S131, the lending management unit 130 judges whether it is past a lending end time registered in the selected record. When it is past the lending end time, the processing is caused to proceed to a step S136. When it is not past the lending end time, the processing is caused to proceed to a step S132.

In the step S132, the lending management unit 130 judges whether it is past a time preceding the lending end time by a predetermined time, for example, a time preceding by 15 minutes. When it is past a time preceding the lending end time by a predetermined time, the processing is caused to proceed to a step S133. When it is not past a time preceding the lending end time by a predetermined time, the processing is caused to proceed to the step S127.

In the step S133, the lending management unit 130 transmits, to the information processing device 400, a lending-end preliminary announcement notice including an extendible time, and causes the information processing device 400 to offer a response on the extended amount of time of the lending reservation time period. The extendible time is calculated on the basis of, for example, the lending reservation table 111 in the following way.

First, from the lending reservation table 111, the lending management unit 130 extracts all records where the same identifier of a PC as the record selected in the step S121 in FIG. 17 is registered. Next, on the basis of lending time periods registered in the extracted records, the lending management unit 130 judges the earliest reserved lending start time. The lending management unit 130 calculates, as the extendible time, a time elapsing from the lending end time in the record selected in the step S121 to a time preceding the judged earliest lending start time by a predetermined time.

In a step S134, the lending management unit 130 judges whether an extension request notice has been received from the information processing device 400. The extension request notice includes information indicating the extended amount of time of the lending reservation time period. When the extension request notice has been received, the processing is caused to proceed to a step S135. When the extension request notice has not been received, the processing is caused to proceed to the step S127.

That the extension request notice has not been received may be judged, for example, on the basis that the extension request notice has not been received after a predetermined time (for example, five minutes) has elapsed from the transmission of the lending-end preliminary announcement notice. In addition, it may also be judged based on whether the information processing device 400 transmits, to the lending reservation device 100, an extension rejection notice indicating no extension and the lending reservation device 100 receives this notice.

In the step S135, in the lending reservation table 111, the lending management unit 130 updates the lending end time registered in the record selected in the step S121, to a value obtained by adding the received extended amount of time.

In the step S136, the lending management unit 130 transmits a shutdown request to the information processing device 400.

In a step S137, the lending management unit 130 deletes the record selected in the step S121, from the lending reservation table 111.

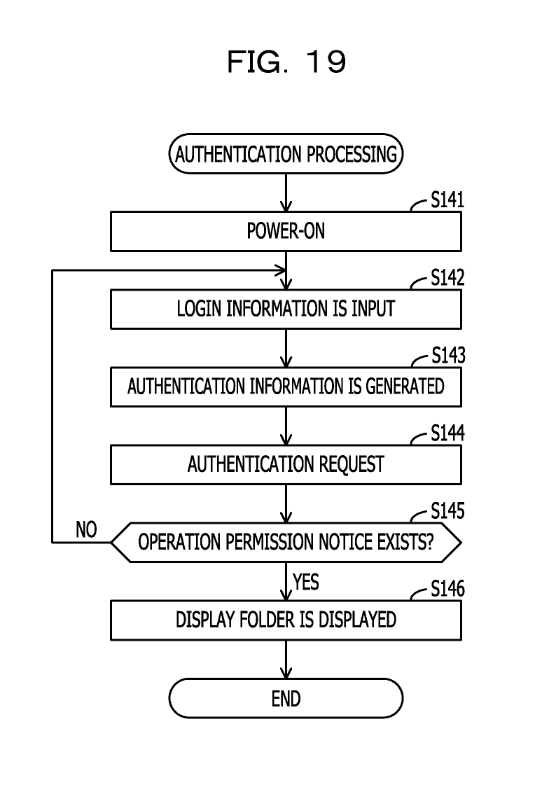

FIG. 19 is a flowchart illustrating an example of authentication processing. Hereinafter, the processing illustrated in FIG. 19 will be described along step numbers.

In a step S141, in response to the input operation of a user, the information processing device 400 is put from a power-off state into a power-on state.

In a step S142, the operation start unit 410 causes a display to display the input screen of login information including a user ID and a password, and receives the input of the login information from the user 6. As the login information, the login information the lending reservation registration unit 120 has given notice of in the step S114 in FIG. 16 is used.

In a step S143, on the basis of the input login information, the operation start unit 410 generates authentication information. The authentication information includes an authentication ID and a password. The authentication ID is generated by adding the MAC address of the information processing device 400 to the user ID included in the login information. As the password, the password included in the input login information is used without change.

In a step S144, the operation start unit 410 transmits, to the domain controller 200, an authentication request including the authentication information of the user.

In a step S145, the operation start unit 410 judges whether an operation permission notice including information relating to a display folder has been received from the domain controller 200. When the operation permission notice has been received, the processing is caused to proceed to a step S146. When the operation permission notice has not been received, the processing is caused to proceed to the step S142.

Whether the operation permission notice has not been received may be judged, for example, on the basis that the operation permission notice has not been received after a predetermined time, for example, one minute has elapsed from the transmission of the authentication request. In addition, it may also be judged based on whether the lending reservation device 100 transmits, to the information processing device 400, an operation rejection notice indicating the rejection of an operation and the information processing device 400 receives the operation rejection notice.

In the step S146, on the basis of the information relating to the display folder, included in the operation permission notice, the operation start unit 410 causes the display folder to be displayed on the display 41. The detail of the processing is as described in the steps S27 to S33 in FIG. 14.

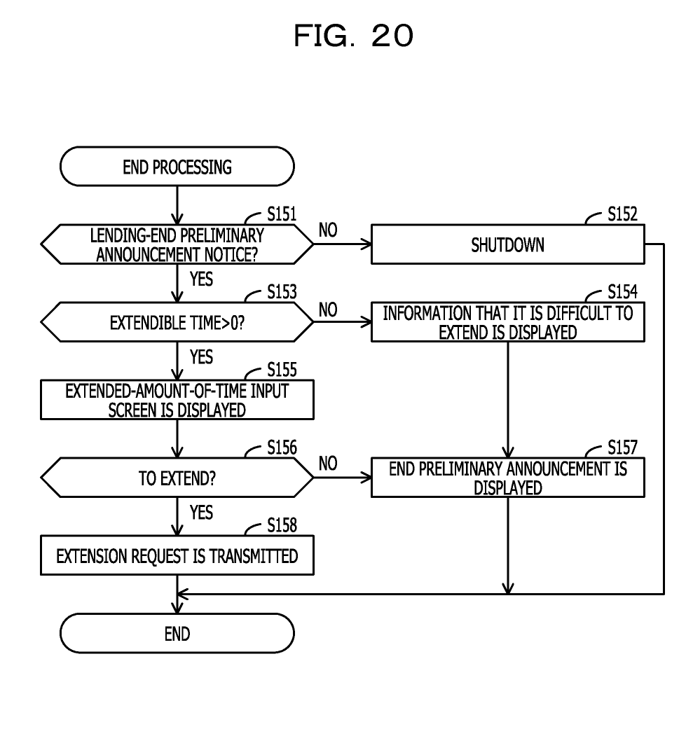

FIG. 20 is a flowchart illustrating an example of lending end processing. The processing illustrated in FIG. 20 is processing performed when the information processing device 400 has received a lending-end preliminary announcement notice or a shutdown request from the lending reservation device 100. Hereinafter, the processing illustrated in FIG. 20 will be described along step numbers.

In a step S151, the end processing unit 420 judges whether data received from the lending reservation device 100 is a lending-end preliminary announcement notice. When the received data is the lending-end preliminary announcement notice, the processing is caused to proceed to a step S153. When the received data is the shutdown request, the processing is caused to proceed to a step S152.

In the step S152, the end processing unit 420 shuts down the information processing device 400. In addition, the end processing unit 420 may also log off the information processing device 400 in place of shutdown. The same applies to the following description.

In the step S153, the end processing unit 420 judges whether an extendible time included in the lending-end preliminary announcement notice is larger than “0”. When the extendible time is larger than “0”, the processing is caused to proceed to a step S155. When the extendible time is “0”, the processing is caused to proceed to a step S154.

In the step S154, the end processing unit 420 displays, on the display 41, the information that it is difficult to extend.

In the step S155, on the display 41, the end processing unit 420 displays an extendible time, and an extended-amount-of-time input screen causing the user to input an extended amount of time.

In a step S156, the end processing unit 420 judges whether the user 6 has input information indicating extension. When the information indicating extension has been input, the processing is caused to proceed to a step S158. When the information indicating extension has not been input, the processing is caused to proceed to a step S157.

In the step S157, the end processing unit 420 displays an end preliminary announcement on the display 41. At this time, a notice indicating no extension may also be transmitted to the lending reservation device 100.

In the step S158, the end processing unit 420 transmits, to the lending reservation device 100, an extension request including the input extended amount of time.

According to the lending reservation system 5 of the second embodiment, the lending reservation device 100 notifies the user who made a reservation of the login information for allowing the information processing device to be used, and registers, in the authentication table 211, the authentication information based on the login information given notice of. Owing to this, it may be possible to restrict a user who uses the information processing device 400.

In addition, the lending reservation device 100 controls the domain controller 200 so that the authentication information of a user is registered in the authentication table 211 for only the lending time period. The information processing device 400 whose lending has been reserved transmits the authentication information to the domain controller 200, and requests authentication. When the received authentication information has been stored in the authentication table 211, the domain controller 200 permits the operation of the information processing device 400. Since a time period for which the authentication information is registered in the authentication table 211 is restricted to the lending time period, it becomes difficult for the user 6 to use the information processing device 400 at a time falling outside the reserved lending time period. Accordingly, it may be possible to restrict the usage time period of the information processing device lent to the user.

In addition, the lending reservation device 100 notifies the user who made a reservation of the login information including the user ID, generates the authentication ID by adding the MAC address of the information processing device 400 to the user ID when it is past a time preceding the lending start time by a predetermined time, and registers, in the authentication table 211, the authentication information including the generated authentication ID. After that, when having received the input of the login information from the user 6, the information processing device 400 generates the authentication ID obtained by adding the MAC address of the information processing device 400 to the user ID included in the login information whose input has been received. In addition, the information processing device 400 transmits, to the domain controller 200, the authentication information including the generated authentication ID, and requests authentication.

Here, in a method where the domain controller 200 performs authentication using only the login information of which the lending reservation device 100 has notified the user, the operation of an information processing device B1 other than a reserved information processing device A1 is permitted by, for example, inputting the login information of which a user A has been notified. Therefore, for example, a case occurs where the information processing device B1 not reserved for the user A is used and it becomes difficult for a user B who has reserved the information processing device B1 to use the information processing device B1 for a specified time period.

Therefore, for the authentication due to the domain controller 200, the authentication ID is used that is obtained by adding, to the user ID, the MAC address of the information processing device 400 whose lending has been reserved. Owing to this, even if the user A inputs the login information to the information processing device B1 not reserved, the domain controller 200 does not permit the operation thereof. Therefore, it is difficult for the user A to use the information processing device B1. Accordingly, the information processing device lent to the user 6 who made a reservation is restricted.

In addition, when it comes to a time preceding the lending start time by a predetermined time, the lending reservation device 100 stores, in the display folder table 321, the information relating to the display folder. When the domain controller 200 has permitted the operation of the information processing device, the information processing device receives, from the domain controller 200, the information relating to the display folder, and causes the display 41 to display the display folder on the basis of the received information relating to the display folder. Owing to this, when the lent information processing device 400 has become operable, the usage time period of the display folder displayed on the display 41 is restricted.

In addition, when it comes to the lending end time, the lending reservation device 100 causes the information processing device to be shut down. Owing to this, the use of the information processing device is avoided that exceeds the lending time period.

In addition, when it comes to a time preceding the end time of the lending time period by a predetermined time, the lending reservation device 100 notifies the information processing device 400 of an end preliminary announcement. Owing to this, it may be possible for the user 6 who uses the information processing device 400 to secure a time for preparing for the shutdown of the information processing device 400.

In addition, when information relating to a lending reservation due to the user has been input, the lending reservation device 100 judges, on the basis of the affiliation of the user 6 who has made a reservation, whether it is possible to access the display folder, and when it has not been judged that it is possible to access, the lending reservation device 100 may also give notice to that effect to the user. Whether it is possible to access is judged, for example, in the following way.

First, the lending reservation device 100 searches for a record in which the affiliation destination of the user 6 is set, from the affiliation table 322, and reads information indicating the type of access authority set in the record searched for. Next, the lending reservation device 100 reads the path information of a display folder included in information relating to a lending reservation. Next, the lending reservation device 100 searches for a record in which the read path information is set, from the authority information table 323, and reads authority set in the record searched for. In addition, when the information, which has been read from the affiliation table 322 and indicates the authority, and the information, which has been read from the authority information table 323 and indicates the authority, coincide with each other, the lending reservation device 100 judges that it is possible to access the display folder.

Owing to this, it may be possible for the lending reservation system 5 to restrict the display folder the lent information processing device 400 is caused to display, to a folder that the affiliation destination of the user 6 is permitted to access.

In addition, as described above, it may be possible for the information processing of the first embodiment to be realized by causing the information processing device 3, the lending management device 10, or the authentication device 20 to execute a program, and it may be possible for the information processing of the second embodiment to be realized by causing the lending reservation device 100, the domain controller 200, the file server 300, or the information processing device 400 or 400a to execute a program. Such a program may be recorded in a computer-readable recording medium, for example, the recording medium 43. As the recording medium, for example, a magnetic disk, an optical disk, a magnet-optical disk, a semiconductor memory, or the like may be used. Examples of the magnetic disk include an FD and an HDD. Examples of the optical disk includes a CD, a recordable rewritable CD (CD-R/RW), a DVD, and a recordable rewritable DVD (DVD-R/RW).

When a program is distributed, for example, portable recording media are provided that record therein the corresponding program. In addition, the program may be stored in a storage device of another computer, and the program may also be distributed through the network 30. A computer stores, in a storage device, for example, the HDD 103, the program recorded in, for example, a portable recording medium or the program received from another computer, and reads and executes the program from the corresponding storage device. In this regard, however, the program read from the portable recording medium may also be directly executed, and the program received from another computer through the network 30 may also be directly executed. In addition, at least a portion of the above-mentioned information processing may also be realized by an electronic circuit such as digital signal processing (DSP), an ASIC, or a programmable logic device (PLD).

All examples and conditional language recited herein are intended for pedagogical purposes to aid the reader in understanding the embodiments and the concepts contributed by the inventor to furthering the art, and are to be construed as being without limitation to such specifically recited examples and conditions, nor does the organization of such examples in the specification relate to a showing of the superiority and inferiority of the embodiments. Although the embodiments have been described in detail, it should be understood that the various changes, substitutions, and alterations could be made hereto without departing from the spirit and scope thereof.

What is claimed is:

1. A management system, comprising:
a memory storing first information including a user identification and a first reservation time period of an information processing device, and
a processor coupled to the memory and configured to
activate the first information at a start of the first reservation time period,
deactivate the first information at an end of the first reservation time period,
receive the first information from the information processing device, and
permit an operation of the information processing device based on the first information stored in the memory and the first information sent by the information processing device.

2. The management system according to claim 1, wherein
the memory includes a first memory and a second memory, and
the processor includes a first processor and a second processor, wherein
the first memory stores the first information and the first reservation time period,
the a first processor is coupled to the first memory and is configured to transmit the first information from the first memory to the second memory at the start of the first reservation time period and discard the first information stored in the second memory at the end of the first reservation time period, and
the second processor is coupled to the second memory and is configured to permit an operation of the information processing device based on the first information stored in the second memory and the first information sent by the information processing device.

3. The management system according to claim 2, wherein
the first processor is configured to request the second processor to store second information of the information processing device at the start of the first reservation time period and discard the second information at the end of the first reservation time period,
the information processing device transmits the second information to the management system, and
the second processor is configured to permit the operation of the information processing device when the second memory holds the second information at a second information transmission time of transmission of the second information from the information processing device.

4. The management system according to claim 2, wherein
the first processor is configured to request the information processing device to terminate operation in association with an end time of the first reservation time period.

5. The management system according to claim 4, wherein
the first processor is configured to notify the information processing device of an end preliminary announcement of the first reservation time period when in association with a preceding time preceding the end time of the first reservation time period by a predetermined time.

6. The management system according to claim 5, wherein
the first processor is configured to calculate, as an extendible time, an elapsed time elapsing from the end time of the first reservation time period to a second reservation start time of a second reservation time, and notify the information processing device of the extendible time along with the end preliminary announcement of the first reservation time period.

7. The management system according to claim 2, further comprising a storage device, wherein:
the first processor is configured to cause the storage device to store therein the first information and folder information relating to a folder for the first reservation time period,
the second processor is configured to acquire, from the storage device, the folder information relating to the folder, associated with the first information transmitted from the information processing device, and transmit the information relating to the folder to the information processing device, and
based on the transmitted information relating to the folder, the information processing device causes the folder to be displayed on a screen of the information processing device and accesses the storage device.

8. A management method of an information processing device, the management method comprising:
activating first information including a user identification stored in a memory at a start of a first reservation time period of an information processing device;
deactivating the first information at an end of the first reservation time period;
receiving the first information from the information processing device; and
permitting an operation of the information processing device based on the first information stored in the memory and the first information sent by the information processing device.

9. The management method according to claim 8, wherein
the memory includes a first memory and a second memory, the first memory stores the first information and the first reservation time period, and
the managing method further comprises:
transmitting the first information from the first memory to the second memory at the start of the first reservation time period and discard the first information stored in the second memory at the end of the first reservation time period; and
permitting an operation of the information processing device based on the first information stored in the second memory and the first information sent by the information processing device.

10. The management method according to claim 8, further comprising:
storing, in the second memory, second information of the information processing device at the start of the first reservation time period;
discarding the second information at the end of the first reservation time period;
receiving the second information from the information device; and
permitting the operation of the information processing device when the second memory holds the second information at a second information transmission time of transmission of the second information from the information processing device.

11. The management method according to claim 9, further comprising requesting the information processing device to terminate operation in association with an end time of the first reservation time period.

12. The management method according to claim 9, further comprising notifying the information processing device of an end preliminary announcement of the first reservation time period in association with a preceding time preceding an end time of the first reservation time period by a predetermined time.

13. The management method according to claim 12, further comprising:
calculating as an extendible time, an elapsed time elapsing from the end time of the first reservation time period to a reservation time start time of a second reservation time; and
notifying the information processing device of the extendible time along with the end preliminary announcement of the first reservation time period.

14. The management method according to claim 9, further comprising:
causing the first information and folder information relating to a folder to be stored in a storage device, for at least a lending reservation time period;
acquiring in the authentication device, from the storage device, the folder information relating to the folder, associated with the first information transmitted from the information processing device, and transmitting the folder information relating to the folder to the information processing device; and
causing, in the information processing device, on the basis of the transmitted folder information relating to the folder, the folder to be displayed on a screen of the information processing device and accessing the storage device.

15. A non-transitory computer-readable storage medium storing a program that causes an information processing apparatus to execute a process, the process comprising:
activating first information including a user identification stored in a memory at a start of a first reservation time period of an information processing device;
deactivating the first information at an end of the first reservation time period;
receiving the first information from the information processing device; and
permitting an operation of the information processing device based on the first information stored in the memory and the first information sent by the information processing device.

16. A method, comprising:
storing a reservation, having a reservation period, for an information processing device and user identification of a user making the reservation for the reservation period;
authenticating the user when a request by the user to use the information processing device is received; and
granting operating permission to the information processing device to operate only for the reservation period when the user is authenticated.

17. The method according to claim 16, wherein
the reservation is stored for the authenticating only for the reservation period.

18. The method according to claim 16, further comprising sending a shutdown request to the information processing device at an end of the reservation period.

19. The method according to claim 16, further comprising sending a reservation period end notice to the information processing device near an end of the reservation period.

20. The method according to claim 18, further comprising restricting information access by the information processing device responsive to an affiliation of the user.
